(19) United States
(12) Patent Application Publication
(10) Pub. No.: US 2015/0172789 A1
(43) Pub. Date: Jun. 18, 2015

(54) SIMPLE LOW-COST ORIENTATION SENSOR FOR CONTROL OF HANDHELD DEVICE

(71) Applicant: KONINKLIJKE PHILIPS N.V., EINDHOVEN (NL)

(72) Inventors: Eng Kim Teo, Singapore (SG); Hwai Kiang Tan, Singapore (SG)

(21) Appl. No.: 14/408,072

(22) PCT Filed: Jun. 19, 2013
(86) PCT No.: PCT/IB2013/055035

§ 371 Date: Dec. 15, 2014

Related U.S. Application Data
(60) Provisional application No. 61/665,364, filed on Jun. 28, 2012.

(51) Int. Cl. H04Q 9/00

(52) U.S. Cl. CPC H04Q 9/00

(57) ABSTRACT

A handheld electronic device (100; 200) has a user-interface (102), a sensor (104) for sensing an orientation of the device with respect to gravity, and electronic circuitry (108) for controlling operation of the device in dependence on the orientation sensed. The sensor has a contact object (300) that assumes, under control of gravity, different positions with respect to a housing of the device in different orientations of the device. The sensor has a substrate (702) mounted stationary with regard to the device. The substrate has a first pair of electrical contacts (704) connected to the electronic circuitry and a second pair of contacts (706) connected to the electronic circuitry. The contact object has a surface (402) that faces the substrate. The surface electrically interconnects the first pair of contacts if the contact object assumes the first position and electrically interconnects the second pair of contacts if the contact object assumes the second position.

### FIELD OF THE INVENTION

The invention relates to a handheld electronic device comprising a user-interface configured for enabling a user to interact with the handheld electronic device, an orientation sensor configured for sensing a respective one of multiple orientations of the handheld electronic device relative to gravity; and electronic circuitry operative to control operation of the handheld electronic device in dependence on the respective orientation sensed. The invention also relates to an orientation sensor for use in such a device.

### BACKGROUND ART

Handheld electronic devices of above configuration are known from, e.g., US patent application publication 2010/0271231, titled “Two-sided handheld remote control” and incorporated herein by reference. US patent application publication 2010/0271231 discloses a two-sided remote control that includes a logic device for controlling and/or communicating with a transmitter and a button detector which detects the statuses of two sets of buttons on opposite sides of the two-sided remote control. Both sets of buttons are in the same locations on their respective faces such that one set of buttons is always oriented upwards and with a set of buttons in locations expected by a user. The two-sided remote control may further include an orientation detector which can be used to cause buttons presses on the buttons of the downward oriented face to be ignored. US patent application publication 2010/0271231 mentions as examples of an orientation detector: a mercury switch, a roller ball sensor, and a cantilever type sensor which bends one way or the other depending on orientation. A capacitance sensor could further be used as an orientation detector by detecting the greater capacitance level of the bottom side compared to the top side when the remote control is held in a hand as the bulk of the mass of the hand is against the bottom of the remote control.

### SUMMARY OF THE INVENTION

Drawbacks of the known orientation sensors, as recognized by the inventors, are one or more of the following: cost of the additional hardware required to functionally and physically integrate the orientation sensor with the handheld electronic device, the relative complexity of installing the orientation sensor at the handheld electronic device, and the reliability of the known orientation sensors.

The inventors propose a handheld electronic device that comprises a user-interface configured for enabling a user to interact with the handheld electronic device; an orientation sensor configured for sensing a respective one of multiple orientations of the handheld electronic device relative to gravity; and electronic circuitry operative to control operation of the handheld electronic device in dependence on the respective orientation sensed. The orientation sensor comprises a contact object. The contact object is operative to assume, under control of gravity, a first position with respect to a housing of the handheld electronic device in dependence on a first one of the multiple orientations. The contact object is operative to assume, under control of gravity, a second position with respect to the housing in dependence on a second one of the multiple orientations. The first position is different from the second position, and the first orientation is different from the second orientation. The orientation sensor has a substrate mounted stationary with regard to the housing and accommodating a first pair of first electrical contacts connected to the electronic circuitry and a second pair of second electrical contacts connected to the electronic circuitry. The contact object has a surface that faces the substrate. The surface is configured for electrically interconnecting the first pair of the first electrical contacts if the contact object assumes the first position and for electrically interconnecting the second pair of the second electrical contacts if the contact object assumes the second position.

Accordingly, a contact object is mounted at the handheld electronic device so as to have the surface of the contact object face the substrate that accommodates two (or more) pairs of electrical contacts. The contact object is mounted so as to assume different positions in different orientations of the handheld electronic device with respect to gravity. In different positions, the surface of the contact object interconnects different pairs of electrical contacts. The contact object thus serves as a gravity-controlled electrically conductive interconnector or switch, operative to make or break an electric circuit of the electronic circuitry. The making or breaking of the electric circuit then controls operation of the handheld electronic device. Note that the surface of the contact object faces the first electrical contacts and the second electrical contacts. A consequence of this configuration is that the first electrical contacts and the second electrical contacts can be accommodated, together with the electronic circuitry, at the same substrate, e.g., a printed-circuit board (PCB), thus simplifying the assembly of the handheld electronic device.

In an embodiment, the contact object and the multiple pairs of electrical contacts are accommodated in a compartment substantially sealed against ingress of foreign matter, such as dust, humidity, etc.

In order to ensure reliable operation of the orientation sensor, foreign matter is preferably prevented from interfering with the changing of position of the contact object under control of gravity, and from interfering with the contact object electrically interconnecting the relevant pair of electrical contacts. The sealing compartment may be implemented by, e.g., the housing of the handheld electronic device or by a separate chamber within the housing.

In a further embodiment, the contact object is arranged to pivot on a pivoting axis. The pivoting axis is stationary to the housing, and the contact object has a center of gravity that lies off the pivoting axis.

As the center of gravity of the contact object lies off the pivoting axis, gravity will cause the contact object to pivot when the orientation of the handheld electronic device changes relative to the direction of gravity. The pivoting is caused by the contact object minimizing its potential energy in the gravitational field and is constrained by the surface of the contact object hitting the relevant one of the pairs of electrical contacts. The pivoting axis may be implemented by an extremity of a rib within the housing of the handheld electronic device and extending from an inner wall of the housing to the substrate.

In a further embodiment, the contact object is formed as a strip with a surface of an electrically conducting material.

For example, the contact object may be formed by a metal strip, e.g., a copper strip or aluminum strip. Alternatively, the contact object is formed by a strip of, e.g., plastic, with an electrically conductive coating of the strip's respective regions that will physically contact the respective pair of electrical contacts. The pivoting axis divides the strip into a first arm and a second arm. By means of designing the first arm and the second arm so that they have substantially unequal masses, the center of gravity of the contact object will lie off the pivoting axis. The first arm and the second arm can be created with unequal masses, for example, by properly adjusting their respective lengths and/or proper profiling and/or folding.

In a further embodiment, the handheld device comprises a remote control device for remotely controlling controllable equipment, e.g., consumer electronics apparatus, in response to the user interacting with the user-interface.

In case the remote control device has a user-interface with manually selectable control options at opposite sides of the housing, the orientation sensor can be used to activate the selectability of the control option at the side facing the user (i.e., at the side substantially turned upwards) and to inactivate the selectability of the control options at the other side (i.e., the side facing downwards) in order to prevent inadvertent selection of a control option at the downwards facing side when the user is holding and interacting with the remote control device in operational use thereof.

In case the remote control device has a user-interface with manually selectable control options at only a single specific side of the housing, the orientation sensor can be used to activate the electronic circuitry if the specific side faces upwards and to inactivate the electronic circuitry if the specific side faces downwards so as to reduce power consumption and/or to prolong battery life.

Handheld electronic devices other than remote control devices may also benefit from an orientation sensor as specified above. Examples of such other handheld electronic devices include gaming devices used with, e.g., video games; mobile telephones or smartphones, personal digital assistants (PDAs) or palmtop PCs, digital cameras, etc.

The invention also relates to an orientation sensor configured for sensing a respective one of multiple orientations relative to gravity. The orientation sensor has a substrate accommodating a first pair of first electrical contacts and a second pair of second electrical contacts. The orientation sensor comprises a contact object. The contact object is operative to assume, under control of gravity, a first position with respect to the substrate in dependence on a first one of the multiple orientations of the substrate with respect to gravity. The contact object is operative to assume, under control of gravity, a second position with respect to the substrate in dependence on a second one of the multiple orientations of the substrate with respect to gravity. The first position is different from the second position, and the first orientation is different from the second orientation. The contact object has a surface that faces the substrate. The surface is configured for electrically interconnecting the first pair of the first electrical contacts if the contact object assumes the first position and for electrically interconnecting the second pair of the second electrical contacts if the contact object assumes the second position.

In an embodiment of the orientation sensor, the contact object and the multiple pairs of electrical contacts are accommodated in a compartment substantially sealed against ingress of foreign matter (dust, humidity, etc.).

In a further embodiment of the orientation sensor, the contact object is arranged to pivot on a pivoting axis. The pivoting axis is stationary to the substrate. The contact object has a center of gravity that lies off the pivoting axis.

In a further embodiment of the orientation sensor, the contact object is formed as a strip with a surface of an electrically conducting material.

### BRIEF DESCRIPTION OF THE DRAWING

The invention is explained in further detail, by way of example and with reference to the accompanying drawing, wherein:

FIGS. 1 and 2 are block diagrams of a handheld electronic device;

FIGS. 2, 3, 4, 5, 6, 7 and 8 are diagrams illustrating an embodiment of an orientation sensor of the invention.

Throughout the Figures, similar or corresponding features are indicated by same reference numerals.

### DETAILED EMBODIMENTS

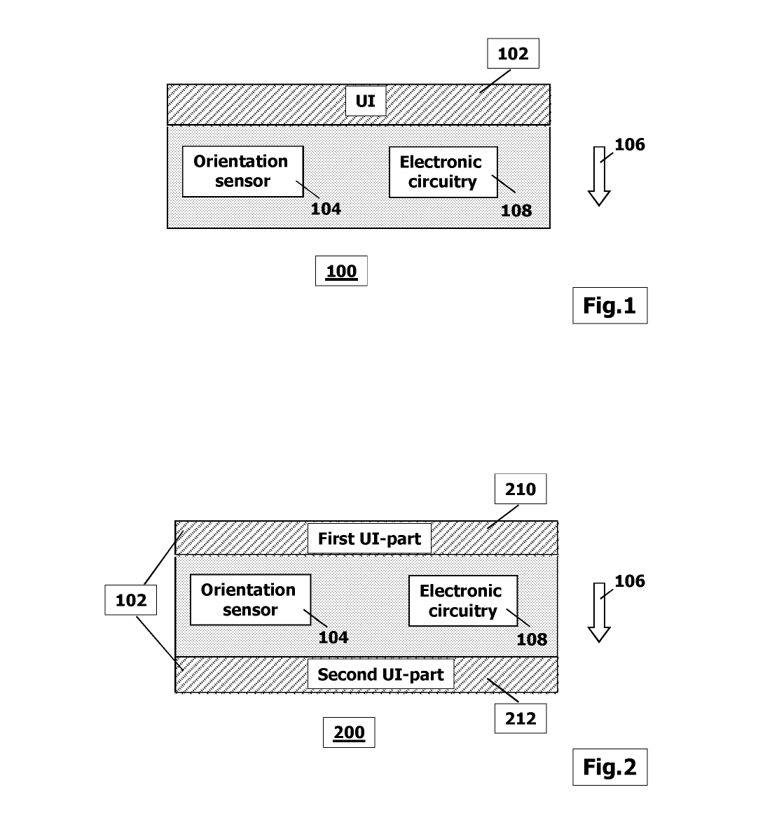

FIG. 1 is a block diagram of a first handheld electronic device 100. The first handheld electronic device 100 comprises a user-interface (UI) 102 configured for enabling a user to interact with the first handheld electronic device 100. The first handheld electronic device 100 also has an orientation sensor 104 configured for sensing different orientations of the first handheld electronic device 100 relative to gravity 106, and electronic circuitry 108 operative to control operation of the first handheld electronic device 100, e.g., of the UI 102, in dependence on the specific orientation of the first handheld electronic device 100 as sensed by the orientation sensor 104.

The first handheld electronic device 100 comprises, e.g., a remote control device for control of controllable equipment through infrared or RF. Examples of such remotely controllable equipment are a television set, a DVD player, an audio set, an airconditioning system, a domestic lighting system, etc. In another example (not shown), the first handheld electronic device comprises, e.g., a smartphone, or a digital camera, or a palmtop personal computer such as a personal digital assistant (PDA). Interaction with the UI 102 then enables the user to activate a particular one of the functionalities provided by the first handheld electronic device 100.

The UI 102 accommodates ergonomically shaped, ergonomically sized and ergonomically arranged user-selectable features (e.g., buttons, keys, sliders, dials, etc., not shown). Interaction with a specific one of the user-selectable features enables the user to select and initiate a specific type of operation of the handheld electronic device 100.

In operational use of the first handheld electronic device 100, the user orients the first handheld electronic device 100 so as to be able to face the UI 102. This orientation enables the user to recognize the user-selectable features available and to select one or more particular ones of the user-selectable features. Accordingly, the orientation of the first handheld electronic device 100 relative to the user determines which one of the surfaces of the handheld electronic device 100 is turned towards the user. In order to be able to interact with the UI 102, the user will typically orient the handheld electronic device 100 so as to have the UI 102 facing upwards, or substantially facing upwards, relative to the direction of gravity 106. As a result, the orientation of the handheld electronic device 100 relative to the direction of gravity 106 can be considered representative of the orientation of the handheld electronic device 100 with respect to the user.

The orientation sensor 104 is configured for sensing the orientation of the first handheld electronic device 100 relative to the direction of gravity 106. The orientation sensor 104 of the first handheld electronic device 100 enables, for example, to turn on the electronic circuitry 108 when the UI 102 of the first handheld electronic device 100 is facing upwards, or substantially upwards, i.e., more or less anti-parallel to the direction of gravity 106, and to turn off the electronic circuitry 108 when the UI 102 of the first handheld electronic device 100 is facing substantially downwards, i.e., in the direction of gravity 106. The turning on of the electronic circuitry 108 can be implemented, e.g., by connecting the electronic circuitry 108 to an onboard power supply (not shown) such as one or more batteries (electrochemical cells). The turning off of the electronic circuitry 108 can be implemented, e.g., by disconnecting the electronic circuitry 108 from the onboard power supply.

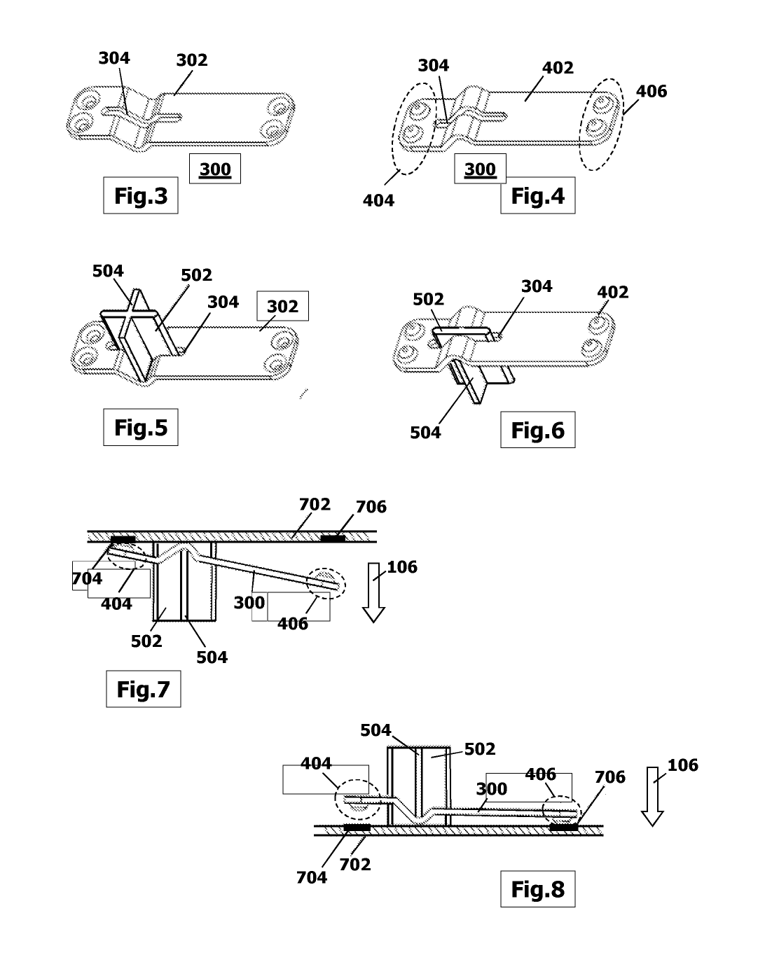

FIG. 2 is a block diagram of a second handheld electronic device 200. The UI 102 of the second handheld electronic device 200 includes a first UI-part 210 accommodated at a surface of the second handheld electronic device 200, and a second UI-part 212 accommodated at an opposite surface of the second handheld electronic device 200. The UI 102 may include additional UI-parts (not shown) at one or more other surfaces of the second handheld electronic device 200. Such a spatial partitioning of the UI 102 may become necessary to make full use of the surface area available at the second handheld electronic device 200 for accommodating ergonomically shaped, ergonomically sized and ergonomically arranged buttons, keys, sliders, dials, and other manually operated features that enable the user to select the type of interaction with the handheld electronic device 200. The ergonomic character of the shape, the size and the spatial arrangement determines the ease with which the user can interact with the UI 102 of the second handheld electronic device 200 and depends on, e.g., the typical dimensions of a tip of a typical user's index finger. This typically implies that the dimensions of a manually operated feature, e.g., a button or key, in the UI 102 are preferably not smaller than a lower bound and, as a result, that the number of manually operated features per unit of surface area of the UI 102 is preferably not larger than an upper bound. Distributing the manually operated features of the UI 102 among two or more surfaces of the second handheld electronic device 200 enables to accommodate more user-selectable manually operated features at a handheld electronic device in an ergonomically acceptable manner than is possible if only a single surface is available.

The orientation of the second handheld electronic device 200 relative to the user determines which one of the surfaces of the second handheld electronic device 200 is turned towards the user. In order to be able to interact with the relevant one of the first UI-part 210 and the second UI-part 212, the user will typically orient the second handheld electronic device 200 so as to have the relevant UI-part facing upwards or substantially upwards, i.e., substantially anti-parallel to the direction of gravity 106. As a result, the orientation of the second handheld electronic device 200 relative to the direction of gravity 106 is representative of which one of the first UI-part 210 and the second UI-part 212 is oriented towards the user. The orientation sensor 104 can then be used to activate the first UI-part 210 and inactivate the second UI-part 212 if the first UI-part 210 faces upwards, i.e., substantially in a direction anti-parallel to the direction of gravity 106, and to activate the second UI-part 212 and inactivate the first UI-part 210 if the second UI-part 212 faces upwards, i.e., substantially in a direction anti-parallel to the direction of gravity 106.

FIGS. 3, 4, 5, 6, 7 and 8 illustrate a simple, low-cost embodiment of the orientation sensor 104. The orientation sensor 104 according to the illustrated embodiment comprises a contact object 300. The contact object has a first surface 302, shown in FIG. 3, and a second surface 402, shown in FIG. 4. The contact object 300 in this embodiment is made of an electrically conductive material throughout, e.g., a metal such as copper, aluminum, or steel, etc. The contact object 300 of this embodiment can be made in an inexpensive manner from a sheet of metal, pressed into the shape as shown with first depressions 404 that will function to interconnect a first pair of first contacts 704 and with second depressions 406 that will function to interconnect a second pair of second contacts 706 on a substrate 702 of the electronic circuitry 108, as shown in FIGS. 7 and 8. The contact object 300 has a slot 304 in a direction substantially perpendicular to a first line (not shown) defined by the positions of the first depressions 404 relative to the contact object 300, and substantially perpendicular to a second line (not shown) defined by the positions of the second depressions 406 relative to the contact object 300. In operational use of the contact object 300, the slot 304 engages with a first rib 502, see FIGS. 5, 6, 7 and 8. The first rib 502 is mounted stationary with regard to a housing (not shown) of the first handheld electronic device 100 or of the second handheld electronic device 200. The first rib 502 serves to guide the movement of the contact object 300 under the influence of gravity as will be explained further below. The contact object 300 is profiled so as to engage also with a second rib 504, see FIGS. 5, 6, 7 and 8. The second rib 504 is also mounted stationary with regard to the housing (not shown) of the first handheld electronic device 100 or of the second handheld electronic device 200. The second rib 504 serves to keep the contact object 300 in position between the second rib 504 and the substrate 702 that accommodates the first pair of contacts 704 and the second pair of contacts 706, allowing the contact object 300 to pivot under the influence of gravity and guided by the first rib 502.

As is clear from FIG. 7, the contact object 300 assumes a first position wherein the contact object 300 bridges the first pair of electrical contacts 704 if the substrate 702 is positioned above the contact object 300 in the gravitational field. And as is clear from FIG. 8, the contact object 300 assumes a second position wherein the contact object 300 bridges the second pair of electrical contacts 706 if the substrate 702 is positioned underneath the contact object 300 in the gravitational field. The substrate 702 is mounted stationary with the housing of the handheld electronic device 100 or 200. As is illustrated in FIGS. 3, 4, 5, 6, 7 and 8, the contact object 300 is substantially of uniform thickness and of uniform width. A first arm of the contact object 300 is the arm that accommodates the first depressions 404 so as to electrically interconnect the first pair of contacts 704 in the first position of FIG. 7. Likewise, a second arm of the contact object 300 is the other arm that accommodates the second depressions 406 so as to electrically interconnect the second pair of contacts 706 in the second position of FIG. 8. The contact object 300 pivots on an axis defined by the extremity of the second rib 504 and the substrate 702. The first arm is substantially shorter than the second arm, as a result of which the center of gravity of the contact object 300 resides somewhere at the second arm. The force of gravity on the contact object 300 is exerted at the center of gravity of the contact object 300. A reaction force is exerted by the substrate 702 or the second rib 504 on one or more locations at the contact object 300 lying on the pivoting axis. The resulting torque will always cause the longer arm to assume a lower position in the gravitational field than the shorter arm. As a result, the pivoting contact object 300 in combination with the stationary first pair of contacts 704 and the stationary second pair of contacts 706 can be used as the orientation sensor 104.

As discussed above, the electronic circuitry 108 controls the operation of the first handheld electronic device 100 or of the second handheld electronic device 200 in dependence on the respective orientation sensed by the orientation sensor 104. In the simple, low-cost embodiment of the orientation sensor 104, the contact object 300 bridges a single one of the first pair of contacts 704 and the second pair of contacts 706 at a time, depending on the orientation assumed. Preferably, the determining of the specific orientation assumed does not require that the contact object 300 electrically bridge the associated one of the first pair of contacts 704 and the second pair of contacts 706 continuously. That is, the electronic circuitry 108 is preferably configured to determine that a specific orientation has been assumed if the relevant one of the first pair of contacts 704 and the second pair of contacts 706 has been bridged for at least a time period of pre-determined length. Similarly, the electronic circuitry 108 is preferably configured to determine that a specific orientation has not changed if the contact object 300 temporarily stops bridging the specific one of the first pair of contacts 704 and the second pair of contacts 706 associated with the specific orientation. A reason for this is that the user holding the first handheld electronic device 100 or the second handheld electronic device 200 may move the first handheld electronic device 100 or the second handheld electronic device 200 for a moment only. As a result of the moving, the contact object 300 may get disconnected for a moment from the specific one of the first pair of contacts 704 and the second pair of contacts 706 associated with the specific orientation. It might even be so that the moving causes other one of the first pair of contacts 704 and the second pair of contacts 706 to get electrically bridged temporarily. In the absence of any further provision, the electronic circuitry 108 may then determine that the orientation has been changed as a result of which a change is triggered in the operational mode of the first handheld electronic device 100 or the second handheld electronic device 200. Therefore, when the electronic circuitry 108 detects that the electrical bridging of the relevant one of the first pair of contacts 704 and the second pair of contacts 706 gets terminated, the electronic circuitry 108 will change the mode of operation of the first handheld electronic device 100 or the second handheld electronic device 200 if the disconnection from the relevant one of the first pair of contacts 704 and the second pair of contacts 706 persists for at least a time period of pre-determined length and/or if the interconnection between the other one of the first pair of contacts 704 and the second pair of contacts 706 persists for at least a further time period of a further pre-determined length.

Typically, a handheld electronic device, e.g., a remote control device o a smartphone, has an onboard main controller unit (MCU) that remains partially on unless the device is completely switched off. If the MCU remains partially on, the activation can be monitored of any user-input, e.g., a pressing of a key in the user-interface, and the processing of the activation can be carried out accordingly. The determining of the orientation assumed by the first handheld electronic device 100 or the second handheld electronic device 200 can therefore be carried out by an MCU forming a part of the electronic circuitry 108.

1. A handheld electronic device comprising:
a user-interface configured for enabling a user to interact with the handheld electronic device;
a housing;
a substrate mounted stationary with regard to the housing;
an orientation sensor configured for sensing a respective one of multiple orientations of the handheld electronic device relative to gravity; and
electronic circuitry operative to control operation of the handheld electronic device in dependence on the respective orientation sensed, the electronic circuitry being accommodated at the substrate;
wherein:
the orientation sensor comprises a contact object;
the contact object is operative to assume, under control of gravity, a first position with respect to a housing of the handheld electronic device in dependence on a first one of the multiple orientations;
the contact object is operative to assume, under control of gravity, a second position with respect to the housing in dependence on a second one of the multiple orientations;
the first position is different from the second position;
the first orientation is different from the second orientation;
the orientation sensor has a first pair of first electrical contacts connected to the electronic circuitry and a second pair of second electrical contacts connected to the electronic circuitry;
the first pair of first electrical contacts and the second pair of second electrical contacts are accommodated at the substrate;
the contact object has a surface that faces the substrate; and
the surface is configured for electrically interconnecting the first pair of the first electrical contacts if the contact object assumes the first position and for electrically interconnecting the second pair of the second electrical contacts if the contact object assumes the second position;
the contacts object is arranged to pivot on a pivoting axis;
the pivoting axis is stationary to the housing; and
the contact object has a center of gravity that lies off the pivoting axis.

2. The handheld device of claim 1, wherein the contact object and the multiple pairs of electrical contacts are accommodated in a compartment substantially sealed against ingress of foreign matter.

3. (canceled)

4. The handheld electronic device of claim 1, wherein the contact object is formed as a strip with a surface of an electrically conducting material.

5. The handheld device of claim 1, comprising a remote control device for remotely controlling controllable equipment in response to the user interacting with the user-interface.

6. (canceled)

7. (canceled)

8. (canceled)

9. (canceled)
